(19) United States
(12) Patent Application Publication
(10) Pub. No.: US 2008/0105767 A1
(43) Pub. Date: May 8, 2008

(54) Fuel injection apparatus

(75) Inventors: Hiroto Fujii, Higashimatsuyama-city (JP); Yuusuke Ootani, Okayama-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/896,935

(22) Filed: Sep. 6, 2007

(30) Foreign Application Priority Data
Sep. 7, 2006 (JP) 2006-243308

(51) Int. Cl. B05B 1/32

(52) U.S. Cl. 239/533.2; 239/584

(57) ABSTRACT

A fuel injection apparatus includes a nozzle portion, into which fuel flows. The nozzle portion includes at least one nozzle hole. Fuel is injected through the at least one nozzle hole. Each of the at least one nozzle hole includes a nozzle hole outlet region. A cross-sectional area of the nozzle hole outlet region decreases continuously or stepwise in a direction opposite from a fuel flowing direction.

### CROSS REFERENCE TO RELATED APPLICATION

This application is based on and incorporates herein by reference Japanese patent application No. 2006-243308 filed on Sep. 7, 2006.

### BACKGROUND OF THE INVENTION

1. Field of the Invention

The present invention relates to a fuel injection apparatus.

2. Description of Related Art

Conventionally, an apparatus stated in JP-A-2006-200378, for example, has been known as a fuel injection apparatus, which injects and feeds high-pressure fuel directly into a combustion chamber within an engine cylinder in, for example, a diesel engine. Now, an example of the configuration of a diesel-engine fuel injection apparatus which has hitherto been generally adopted, including also the apparatus stated in JP-A-2006-200378, will be described especially on the structure of an injection portion (nozzle portion), with reference to FIG. 15. FIG. 15 is a schematic view showing on an enlarged scale, the injection portion (nozzle portion) of a multihole type fuel injection valve for use in the apparatus. Although not shown for the sake of description here, an actuator for a nozzle needle 52 which opens and closes a fuel path leading to fuel injection holes, and other various elements concerning a valve mechanism are disposed on the rear end side (needle lift-off side) of a cylindrical nozzle body 51.

As shown in FIG. 15, the cylindrical nozzle body 51 constituting the injection portion (nozzle portion) of the apparatus has its diameter reduced toward the front end side thereof, and it is partly expanded outward at its front end part 51a at the frontmost end thereof. A hemispherical injection chamber B is formed in the inner space of the expansion. In addition, columnar nozzle holes 51b in which the path has a constant cross-sectional area, are provided in the front end part 51a in a number which is required as the fuel injection holes for communicating the interior and exterior of the front end part 51a, and these nozzle holes 51b are connected (communicated) with one another through the injection chamber B. Besides, the nozzle needle 52 which opens and closes the fuel path extending from an accommodation portion D to the nozzle holes 51b is accommodated in the accommodation portion D inside the nozzle body 51, in a manner to be displaceable in the axial direction thereof. The nozzle needle 52 has its front end worked in a tapered shape, and it is axially displaced (moved up or down), thereby to come near to or away from a inner wall (reduced diameter portion) of the nozzle body 51, which is similarly formed in a tapered shape, at a seat portion C located upstream of the injection chamber B on the upper stream side in the jet ports 51b. More specifically, the distance between the tapered oblique surface 52a (seat surface) of the nozzle needle 52 and the oblique surface 51c of the inner wall of the nozzle body 51 opposing thereto is variable in accordance with the magnitude of the upward displacement quantity (lift quantity) of the needle 52. More specifically, when the lift quantity of the nozzle needle 52 is the smallest (when the needle is seated), the opposing surfaces lie in touch, and no gap exists between these opposing surfaces. As the lift quantity becomes larger, the opposing surfaces are spaced more, and the gap between them enlarges more.

The apparatus controls energization/deenergization for such an injection valve in binary fashion, whereby the lift quantity of the nozzle needle 52 is made variable in accordance with an energization time period, and a fuel fed from an accommodation portion D-side is finally injected to the outside A of the valve by passing through the seat portion C, injection chamber B and nozzle holes 51b in succession. More specifically, in the apparatus, when the injection valve is deenergized (turned OFF), the needle 52 is urged toward the front end side (toward nozzle holes 51b) by an urging member, for example, a coiled spring. Thus, the path between the needle 52 and the inner wall surface of the nozzle body 51 is closed to establish a state (seated needle state) where a fuel feed path from the accommodation portion D to the nozzle holes 51b are cut off at the seat portion C between the accommodation portion D and the injection chamber B. On the other hand, when the injection valve is energized (turned ON), the needle 52 is actuated by a predetermined actuator, and it is displaced upward (lifted off) continually during the energization until a lift-off limit is reached. Thus, the needle 52 is separated from the oblique surface 51c, and the seat portion C is opened, so that the fuel from the accommodation portion D is fed into the injection chamber B through the seat portion C, and is further injected to the outside A of the valve through the nozzle holes 51b. Besides, in the apparatus, an flow passage area of part (the seat portion C) of the fuel feed path is made variable in accordance with the lift quantity of the needle 52, and an injection ratio (a fuel quantity which is injected per unit time) is also made variable in accordance with the flow passage area. Therefore, the injection ratio and the injection quantity can be controlled on the basis of parameters (the energization time period and a fuel pressure) concerning the lift quantity of the needle 52.

In the apparatus exemplified in FIG. 15, a spraying manner of fuel which is injected from the nozzle holes 51b is basically constant, and it cannot be controlled. In a vehicular engine or the like, however, an optimum spraying manner changes in accordance with the operating state of the engine, and it is desired to inject the fuel in the optimum spraying manner corresponding to the engine operating state on each occasion. In recent years, therefore, studies have been made on developing and putting to practical use an apparatus in which fuel injections in a plurality of different spraying manners are permitted by a single fuel injection device (fuel injection valve).

By way of example, there has been an apparatus wherein, as stated in JP-A-2006-105067, a plurality of nozzle needles are provided for corresponding nozzle holes, and the actuations of the nozzle needles are individually controlled, whereby the plurality of nozzle holes are permitted to be selectively opened and closed.

Besides, there has been proposed an apparatus wherein, as stated in JP-A-2001-263201, a valve of rotary type is disposed so as to make variable the cross-sectional areas of individual nozzle holes formed in a nozzle body, and the rotational position of the valve is controlled, whereby any desired nozzle hole selected from among the plurality of nozzle holes is permitted to inject a high-pressure fuel.

With these apparatuses, however, increase in the number of components and complication in structure have been inevitable.

### SUMMARY OF THE INVENTION

The present invention addresses the above disadvantages. Thus, it is an objective of the present invention to provide a fuel injection apparatus in which fuel is injected in a plurality of different spraying manners using a simpler structure.

To achieve the objective of the present invention, there is provided a fuel injection apparatus including a nozzle portion, into which fuel flows. The nozzle portion includes at least one nozzle hole. Fuel is injected through the at least one nozzle hole. Each of the at least one nozzle hole includes a nozzle hole outlet region. A cross-sectional area of the nozzle hole outlet region decreases one of continuously and stepwise in a direction opposite from a fuel flowing direction.

To achieve the objective of the present invention, there is also provided a fuel injection apparatus including a nozzle portion, into which fuel flows. The nozzle portion includes at least one nozzle hole. Fuel is injected through the at least one nozzle hole. Each of the at least one nozzle hole is configured such that a separation position located between an inlet and outlet end portion of the each of the at least one nozzle hole is variable according to a flowing speed of fuel. At the separation position, fuel separates from a wall surface of the each of the at least one nozzle hole while flowing from the inlet end portion to the outlet end portion of the each of the at least one nozzle hole.

Furthermore, to achieve the objective of the present invention, there is provided a fuel injection apparatus including a nozzle portion, into which fuel flows. The nozzle portion includes at least one nozzle hole. Fuel is injected through the at least one nozzle hole. Each of the at least one nozzle hole is configured, such that a separation position located between an inlet and outlet end portion of the each of the at least one nozzle hole is selectable according to a flowing speed of fuel, from the outlet end portion of the each of the at least one nozzle hole, and other positions than the outlet end portion between the inlet and outlet end portion of the each of the at least one nozzle hole. At the separation position, fuel separates from a wall surface of the each of the at least one nozzle hole while flowing from the inlet end portion to the outlet end portion of the each of the at least one nozzle hole.

In addition, to achieve the objective of the present invention, there is provided a fuel injection apparatus including a nozzle, into which fuel flows, and a nozzle needle. The nozzle includes at least one nozzle hole. Fuel is injected through the at least one nozzle hole. Each of the at least one nozzle hole includes a nozzle hole outlet region. A cross-sectional area of the nozzle hole outlet region decreases one of continuously and stepwise in a direction opposite from a fuel flowing direction. The nozzle needle is disposed inside the nozzle thereby to define a fuel supply route, through which fuel flows into the each of the at least one nozzle hole, between the nozzle needle and an inner wall surface of the nozzle, and changes a cross-sectional area of the fuel supply route at a seat portion located on an upstream side of the each of the at least one nozzle hole in the fuel flowing direction. As a result, a flowing speed of fuel flowing through the each of the at least one nozzle hole is changed according to the cross-sectional area of the fuel supply route at the seat portion.

### BRIEF DESCRIPTION OF THE DRAWINGS

The invention, together with additional objectives, features and advantages thereof, will be best understood from the following description, the appended claims and the accompanying drawings in which:

FIG. 1 is a schematic longitudinal sectional view of a fuel injection valve (injector) employed in a fuel injection apparatus according to an embodiment of the present invention;

FIG. 2 is an enlarged view of a nozzle portion (injection portion) according to the embodiment;

FIG. 3A is a sectional view of a nozzle hole of the apparatus according to the embodiment;

FIG. 3B is a schematic view showing a three-dimensional shape of the nozzle hole by a hypothetical outline according to the embodiment;

FIG. 4A is a graph showing a state of a cross-sectional area of a fuel feed path of the fuel injection apparatus (injection valve) in a state of a minimum lift of a needle;

FIG. 4B is a graph showing a state of a cross-sectional area of the fuel feed path in a state of a maximum lift of the needle;

FIG. 5A is an illustrative view showing an injection shape of the fuel injection apparatus in a state of a small lift of the needle (path generally cut off);

FIG. 5B is a partially enlarged view of an area surrounding a nozzle hole of the fuel injection apparatus in FIG. 5A;

FIG. 5C is an illustrative view showing an injection shape of the fuel injection apparatus in a state of a large lift of the needle (needle generally fully lifted up);

FIG. 5D is a partially enlarged view of the area surrounding the nozzle hole in FIG. 5C;

FIG. 6 is a graph showing injection characteristics of the fuel injection apparatus (injection valve);

FIG. 7A is a timing diagram showing one aspect of fuel injection patterns according to the embodiment;

FIG. 7B is a timing diagram showing another aspect of the fuel injection patterns;

FIG. 8A is a sectional view showing a first modified example of a shape of the nozzle hole;

FIG. 8B is a sectional view showing a second modified example of the shape of the nozzle hole;

FIG. 8C is a sectional view showing a third modified example of the shape of the nozzle hole;

FIG. 8D is a sectional view showing a fourth modified example of the shape of the nozzle hole;

FIG. 9A is a sectional view showing a fifth modified example of the shape of the nozzle hole;

FIG. 9B is a sectional view showing a sixth modified example of the shape of the nozzle hole;

FIG. 10A is a sectional view showing a seventh modified example of the shape of the nozzle hole;

FIG. 10B is a sectional view showing an eighth modified example of the shape of the nozzle hole;

FIG. 10C is a sectional view showing a ninth modified example of the shape of the nozzle hole;

FIG. 11A is a sectional view showing a tenth modified example of the shape of the nozzle hole;

FIG. 11B is a sectional view showing an eleventh modified example of the shape of the nozzle hole;

FIG. 11C is a sectional view showing a twelfth modified example of the shape of the nozzle hole;

FIG. 12 is a sectional view showing a modified example of the fuel injection apparatus;

FIG. 13A is a schematic view showing a three-dimensional shape of the nozzle hole by a hypothetical outline according to a modified example of the shape of the nozzle hole;

FIG. 13B is a schematic view showing another three-dimensional shape of the nozzle hole by a hypothetical outline according to a modified example of the shape of the nozzle hole;

FIG. 14A is a sectional view of the nozzle hole according to a modified example of the shape of the nozzle hole;

FIG. 14B is a schematic view showing a three-dimensional shape of the nozzle hole by a hypothetical outline according to the modified example of the shape of the nozzle hole; and

FIG. 15 is an enlarged view of a configuration of a nozzle portion (injection portion) of a previously proposed fuel injection apparatus for a diesel engine.

### DETAILED DESCRIPTION OF THE INVENTION

Now, an embodiment which embodies a fuel injection apparatus according to the present invention will be described with reference to the drawings. The apparatus of this embodiment is mounted in a high-pressure injection system (common-rail system) whose controlled object is, for example, a reciprocating diesel engine being an automotive engine. That is, the apparatus is, in a manner, a fuel injection apparatus for a diesel engine, which is disposed for the diesel engine (internal combustion engine) and is used for injecting and feeding a high-pressure fuel (e.g., under an injection pressure of “1400 atmospheres”) directly into a combustion chamber in an engine cylinder (as direct injection feed) in the same manner as in the foregoing apparatus stated in JP-A-2006-200378.

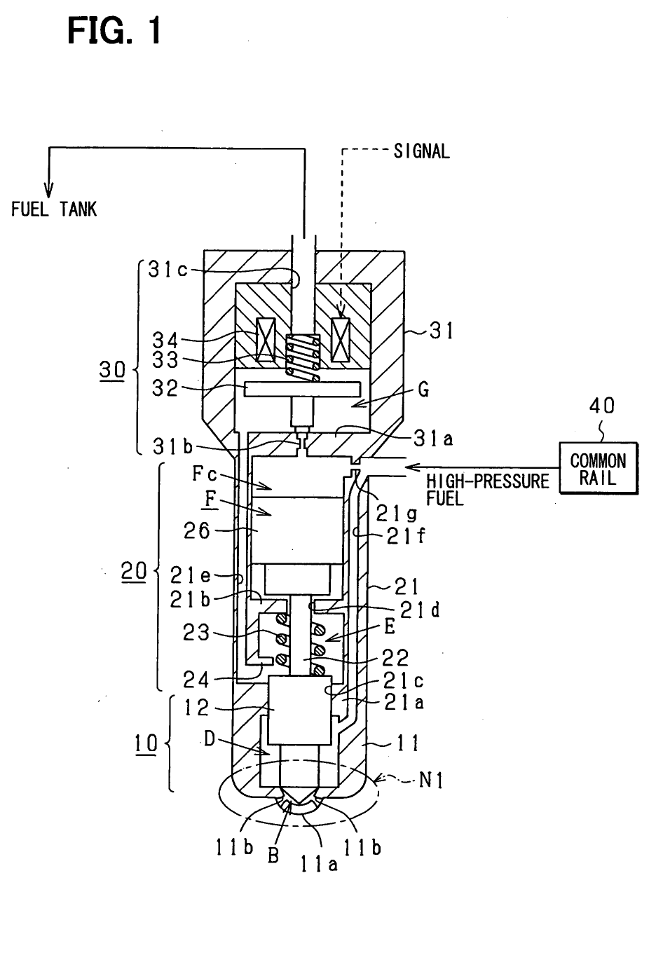

First, the outline of the valve structure of the fuel injection apparatus according to this embodiment will be described with reference to FIG. 1.

As shown in FIG. 1, the fuel injection valve is configured having a nozzle portion (injection portion) 10 for injecting fuel out of the valve through fuel injection holes, on the front end side of a valve body portion 20, and an actuation portion 30 for actuating the valve, on the rear end side of the valve body portion 20. Here, the nozzle portion 10 is formed, for example, in such a way that a nozzle being a separate member is attached to the front end of the valve body portion 20.

The internal space of a nozzle body 11 and housings 21, 31 (these housings may be formed integrally or separately) which define the cylindrical external shapes of the above portions is partitioned by partition plates 21a, 31a in correspondence with the regions of the respective portions, and the region of the valve body portion 20 is further partitioned by a partition plate 21b. Thus, spaces D, E, F, G are formed in the nozzle body 11 and the housings 21, 31, and the adjacent spaces are communicably connected by columnar holes 21c, 21d (formed in the partition plates 21a, 21b, respectively) and an outlet orifice 31b (formed in the partition plate 31a) which are formed round the axis of the valve. Here, the spaces G and E are connected by a leakage passage 21e formed in the interior of the valve. In addition, a fuel passage 21f and an inlet orifice 21g, by which the high-pressure fuel sent from a common rail (pressure accumulation pipe) 40 through a high-pressure fuel pipe (not shown) is caused to flow into the respective spaces D and F, are further formed in the interior of the valve. Besides, the actuation portion 30 is provided with a columnar return hole 31c (fuel return port) for returning the fuel within the space G into a fuel tank, and the space G and the fuel tank are communicably connected through the return hole 31c and an unshown pipe connected to this return hole 31c.

In such an injection valve, fuel injection holes (nozzle holes) are provided at the nozzle portion 10 on the front end side. More specifically, the cylindrical nozzle body 11 has its diameter reduced toward the front end and is partly expanded outward at its front end part 11a at the frontmost end thereof, and a hemispherical space (injection chamber) B is formed (defined) inside the expansion. In addition, the nozzle holes 11b (minute holes) each having a diameter of, for example, about “0.15 mm” are provided in the front end part 11a in a number (e.g., 6 to 8) which is required as the fuel injection holes for communicating the interior and exterior of the valve. That is, the fuel injection valve is a fuel injection valve of the multihole type. The individual nozzle holes 11b are connected (communicated) with one another through the injection chamber B. The nozzle body 11 is made of, for example, a metal, and the nozzle holes 11b may be formed such that they have desired shapes (to be detailed later) by, for example, laser machining. Besides, it may be effective to perform fluid polishing or the like after the laser machining as may be needed.

The structure of the interior of the valve will be described below from the front end side in succession.

First, in the nozzle portion 10, a columnar nozzle needle 12 which opens and closes a fuel path extending from the space (accommodation portion) D to the nozzle holes 11b is accommodated in the accommodation portion D in the nozzle body 11. The nozzle needle 12 is slidden in its axial direction while being guided by the hole 21c, and the area of the path between the accommodation portion D and the injection chamber B (the cross-sectional area of the fuel feed path for feeding fuel to the nozzle holes 11b) is made variable in accordance with the magnitude of the quantity of the axially upward displacement (lift quantity) of the needle 12. That is, in a case, for example, where the fuel injection is stopped in the injection valve, the area of the path between the accommodation portion D and the injection chamber B is made “0” (the path is cut off) by the needle 12.

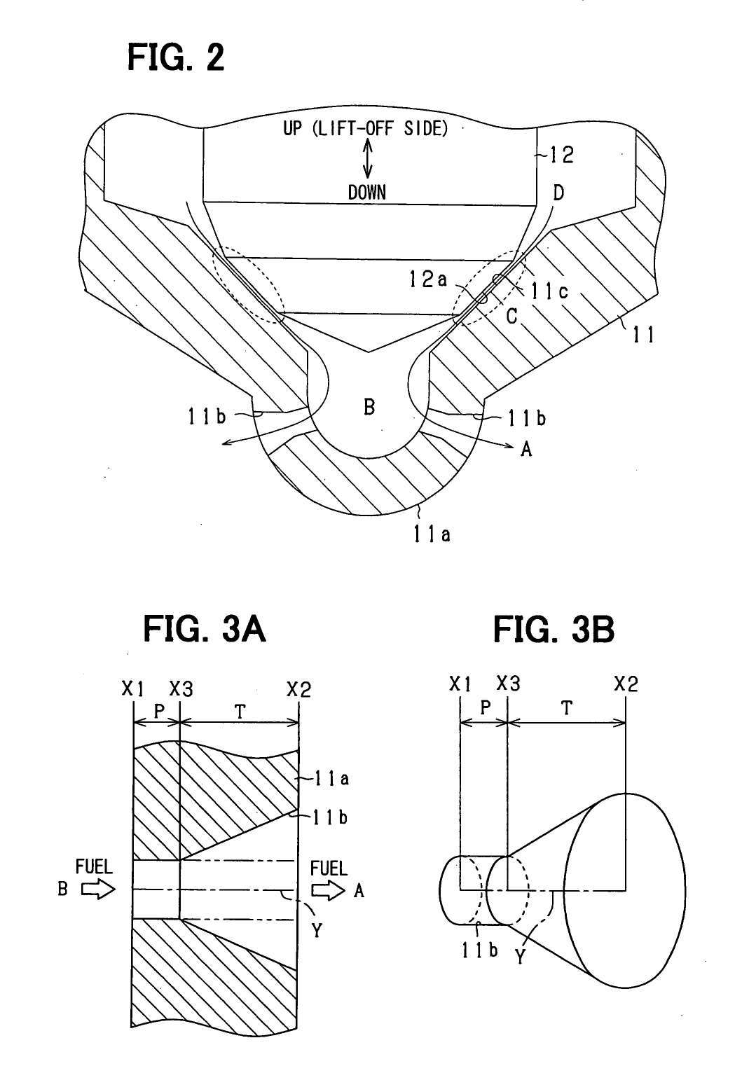

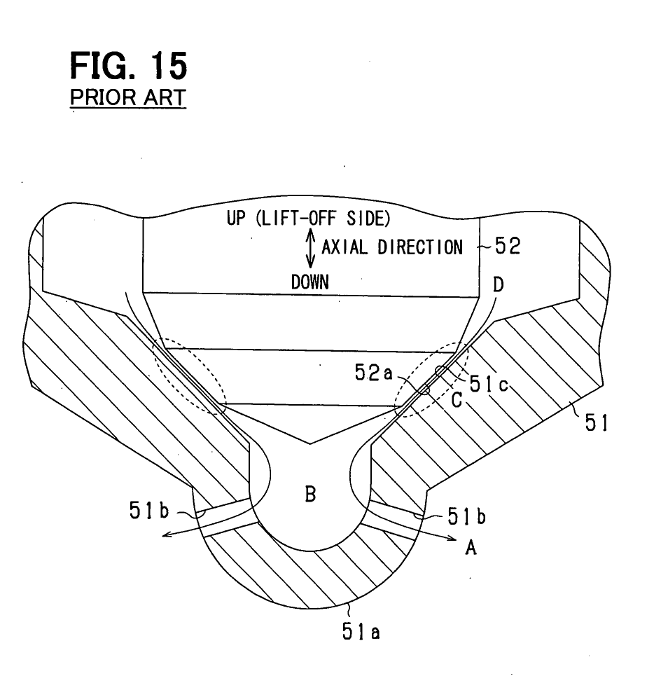

FIG. 2 shows the nozzle portion 10 on an enlarged scale. Incidentally, FIG. 2 corresponds to FIG. 15 referred to before, and it is an enlarged view of a region N1 indicated by a dot-and-dash line in FIG. 1.

As shown in FIG. 2, the nozzle portion 10 of the injection valve is the same in the basic configuration as the foregoing apparatus (injection valve) exemplified in FIG. 15. More specifically, the distal end of the nozzle needle 12 and the inner wall (reduced diameter portion) of the nozzle body 11 are worked in tapered shapes, and the needle 12 is displaced in its axial direction (moved up or down), whereby the distance between the tapered oblique surface 12a (seat surface) of the needle 12 and the tapered oblique surface 11c of the inner wall of the nozzle body 11 opposing thereto, eventually, the cross-sectional area of the fuel feed path for feeding fuel to the nozzle holes 11b is made variable at a seat portion C which is located upstream of the injection chamber B on the upper stream side of the nozzle holes 11b.

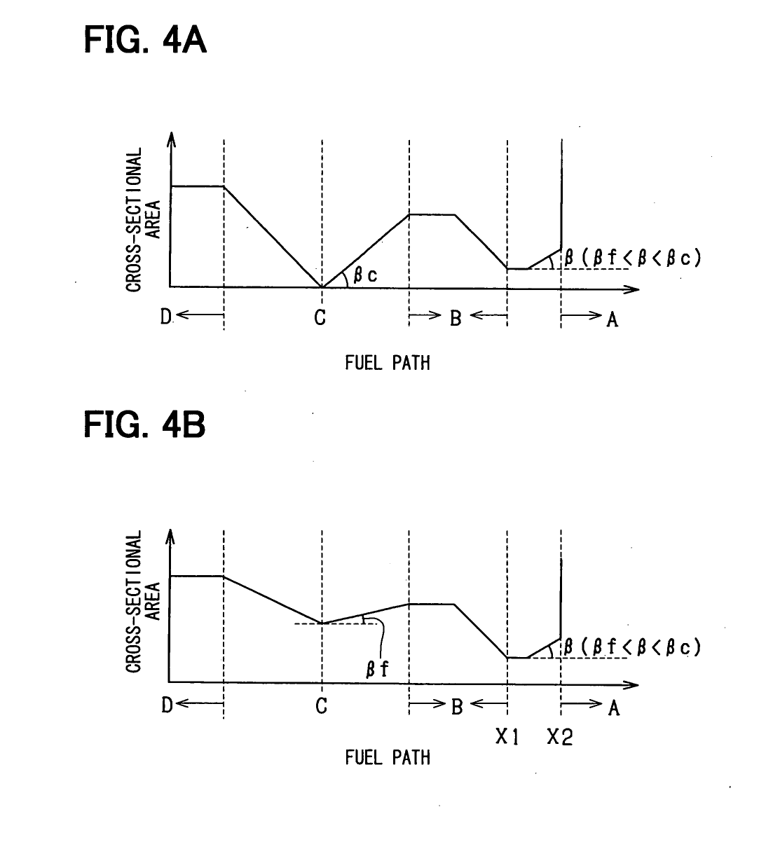

As shown in FIG. 2, however, the shapes of the nozzle holes are greatly different between in the fuel injection apparatus (fuel injection valve) of this embodiment and in the foregoing apparatus in FIG. 15. Now, the shape of each nozzle hole 11b will be detailed with reference to FIGS. 3A to 4B. In addition, FIG. 3B is a schematic view showing the three-dimensional shape of the nozzle hole 11b with virtual contour lines, by supposing a case where only the nozzle hole 11b is seen from a somewhat axial direction side with respect to the viewpoint of FIG. 3A. Besides, in each of FIGS. 3A, 3B, a nozzle hole axis Y indicated by a dot-and-dash line represents the center axis of the nozzle hole 11b extending from the inlet to the outlet of the nozzle hole 11b.

As shown in FIGS. 3A, 3B, the nozzle hole 11b has a region X2-X3 (nozzle hole outlet region) whose cross-sectional area becomes smaller continuously from a nozzle hole outlet end X2 toward a nozzle hole inlet side. More specifically, the region X2-X3 includes a cylindrical tapered bore T whose diameter is reduced concentrically (with the center axis being the nozzle hole axis Y) from the nozzle hole outlet end X2 toward the nozzle hole inlet side, and whose cylindrical surface is a tapered oblique surface.

In FIGS. 3A, 3B, the nozzle hole as the fuel injection hole includes the nozzle hole outlet region. Therefore, in a case where fuel proceeds through the nozzle hole from the nozzle hole inlet side of the nozzle hole outlet region having a smaller cross-sectional area, toward the nozzle hole outlet thereof having a larger cross-sectional area, fuel can separate from the hole wall surface at, at least, the two points of a nozzle hole inlet side end portion and a nozzle hole outlet side end portion (corresponding to the outlet end of the nozzle hole) in the nozzle hole outlet region of the nozzle hole. Moreover, the separation position (at which of these end portions fuel separates) is made variable in accordance with the magnitude of the flowing speed of the fuel. More specifically, as the cross-sectional area of the nozzle hole enlarges, the quantity of fuel which can flow through the nozzle hole increases to that extent. Accordingly, the flowing speed must be lowered in order that fuel continues to flow along the hole wall surface. Besides, regarding the flowing direction of fuel, fuel needs to flow, not only in an inertially flowing direction, but also in an outer direction. In this regard, when the flowing speed of fuel becomes high, fuel flowing through the nozzle hole shown in FIGS. 3A, 3B cannot sufficiently lower the flowing speed (and cannot change the direction) at the position where the cross-sectional area of the nozzle hole changes (enlarges as viewed from the nozzle hole inlet side), and it separates from the hole wall surface.

Ordinarily, the spraying shape of fuel which is injected from the nozzle hole is determined chiefly by a nozzle hole shape at the separation position (especially, a hole inwall surface in contact with fuel) and the state of fuel at the separation (such as the flowing speed and the flowing direction). Therefore, according to the configuration in which such a separation position of fuel is made variable by the magnitude of the flowing speed of the fuel, the spraying shape of fuel can be easily controlled by making variable the magnitude of the flowing speed of fuel flowing through the nozzle hole, even in case of an apparatus which includes a single injection valve and which does not have a plurality of injection valves.

It will be described how the angle of the tapered oblique surface of the tapered bore T is set with reference to FIGS. 4A, 4B. FIGS. 4A, 4B are graphs in each of which its horizontal axis represents the fuel path (fuel feed path), and its vertical axis represents the cross-sectional area of the fuel path. FIGS. 4A, 4B continuously show how the cross-sectional area of the fuel feed path of the injection valve of this embodiment varies, especially how the cross-sectional area of the fuel feed path from the vicinity of the seat portion C to the nozzle hole 11b varies.

As shown in FIGS. 4A, 4B, the injection valve according to this embodiment is provided with the seat portion C (corresponding to the seat of the needle 12) midway from a path having a large cross-sectional area formed in the accommodation portion D (FIG. 2), toward the injection chamber B having a somewhat smaller cross-sectional area than the above path. When the needle 12 is axially displaced, a distance between the tapered oblique surface 12a (seat surface) and the tapered oblique surface (nozzle inner wall) 11c is made variable in the seat portion C, and the state of the cross-sectional area is made variable in correspondence with the movable range of the needle 12, that is, from the state of FIG. 4A to the state of FIG. 4B.

As shown in the graphs, in both the states of FIGS. 4A, 4B, the cross-sectional area increases from the seat portion C toward the downstream side thereof. In this embodiment, two enlargement ratios βc, βf (corresponding to the gradients in the graphs in FIGS. 4A, 4B); the enlargement ratio βc (FIG. 4A) of the cross-sectional area from the seat portion C toward the downstream side thereof, in the state where the cross-sectional area at the seat portion C is minimized by the needle 12, and the enlargement ratio βf (FIG. 4B) of the cross-sectional area from the seat portion C toward the downstream side thereof, in the state where the cross-sectional area at the seat portion C is maximized by the needle 12, are set at values at which separation does not occur at the seat portion C. By setting the enlargement ratios βc, βf at such values, the separation does not occur at the seat portion C no matter where the needle 12 is positioned within its movable range. On the other hand, a cross-sectional area from the nozzle hole inlet end X1 to the nozzle hole outlet end X2 of the nozzle hole 11b has a region (tapered region) whose cross-sectional area becomes smaller continuously from the nozzle hole outlet end X2 toward the nozzle hole inlet side, so as to correspond to the nozzle hole shape shown in FIGS. 3A, 3B. In addition, the angle (diameter enlargement angle) of the tapered oblique surface of the tapered bore T (FIGS. 3A, 3B) is set such that the enlargement ratio β (constant in the region) of the tapered region satisfies the relationship of “βf<β<βc”.

In this manner, the angle of the tapered oblique surface of the tapered bore T (FIGS. 3A, 3B) is set on the basis of the enlargement ratios βc, βf on the downstream side of the seat portion C when the needle 12 lies at the respective limitation positions (minimum and maximum lift positions).

In such a fuel injection apparatus, the cross-sectional area at the seat portion corresponds to the position of the nozzle needle, and the flowing speed of fuel flowing through the nozzle hole corresponds to the cross-sectional area at the seat portion. That is, in such an apparatus, the flowing speed of fuel flowing through the nozzle hole can be controlled by variably controlling the position of the nozzle needle. However, in the state (fully closed state) where the cross-sectional area at the seat portion is minimized by the nozzle needle, the cross-sectional area usually becomes “0” (cutoff state), so that the cross-sectional area enlarges from the seat portion toward the downstream thereof. Also in the state (fully open state) where the cross-sectional area at the seat portion is maximized, the cross-sectional area often enlarges from the seat portion toward the downstream thereof. Here, in the case where the cross-sectional area enlarges, fuel may possibly separate from the hole wall surface while flowing from the seat portion toward the lower stream thereof, depending upon the enlargement ratio of the cross-sectional area. In addition, when fuel separates from the hole wall surface here, the relationship between the position of the nozzle needle and the flowing speed of fuel becomes complicated, or the correlation itself between them disappears, so that the worsening of the controllability is incurred. Accordingly, in order to perform such a control precisely and reliably, the separation at the seat portion should desirably be prevented at any position of the nozzle needle within the movable range thereof. In general, therefore, the enlargement ratios βc, βf are designed at values at which the separation does not occur at the seat portion, in the fuel injection apparatus of this type.

In view of such points, the inventors have invented the above configuration. That is, at least one enlargement ratio β of the portion whose cross-sectional area is enlarged toward a direction of the nozzle hole outlet, in the nozzle hole outlet region is set so as to satisfy the relationship of “βf<β<βc”. More specifically, when the relationship of “β<βc” is satisfied, fuel does not separate even at the portion of the enlargement ratio β, as in the seat portion of the enlargement ratio βc, at least in the state where the cross-sectional area at the seat portion is substantially minimized. On the other hand, regarding the relationship of “β>βf”, in a case where this relationship is not satisfied, that is, where “β≦βf” holds, fuel does not separate at the portion of the enlargement ratio β even when the cross-sectional area of the fuel feed path at the seat portion is maximized, that is, when the position of the nozzle needle is controlled to a position which is most liable to cause the separation. For these reasons, in case of forming the separation point at which fuel does not separate in a region where the cross-sectional area of the fuel feed path at the seat portion is small (the flowing speed of fuel flowing through the nozzle hole is low), and at which fuel separates in a region where the cross-sectional area of the fuel feed path at the seat portion is large (the flowing speed of fuel flowing through the nozzle hole is high), the enlargement ratio β of the portion including the separation point should desirably be set so as to satisfy the relationship of “βf<β<βc”, as in the above configuration. In addition, when such a separation point can be formed, the existence or nonexistence of the separation of fuel, and eventually, the spraying shape can be easily controlled on the basis of the actuation of the nozzle needle (e.g., the magnitude of a lift quantity in case of a nozzle needle of lift type).

Besides, as shown in FIGS. 3A, 3B, a straight bore P (nozzle hole straight portion) being linear (more specifically, columnar with the nozzle hole axis Y being the center axis) is provided as part of the nozzle hole 11b in a region X1-X3 on the upstream side of the region X2-X3 in a fuel flow direction. A cross-sectional area of the straight bore P is constant in the axial direction. The straight bore P acts so as to intensify directivity in the flowing direction of fuel. Concretely, owing to the provision of the straight bore P on the upstream side of the tapered bore T, even when fuel flows into the nozzle hole inlet end X1 of the nozzle hole 11b with scattering directions, the directions (flowing directions) of fuel are substantially uniformalized into the direction of the bore P (direction parallel to the nozzle hole axis Y) when the fuel passes through the straight bore P. Accordingly, fuel of high directivity flows into the tapered bore T.

In the nozzle hole 11b having such a shape, the sectional shapes of the regions X1-X2 of the whole hole, in other words, each sectional shape of the nozzle hole 11b from the inlet to the outlet is a circle round the nozzle hole axis Y. That is, the nozzle hole 11b is formed having a three-dimensional shape of high symmetry such that each of the sections of the regions X1-X2 of the whole hole is point-symmetric with respect to the nozzle hole axis Y as the axis of the symmetry.

In this embodiment, such a nozzle portion 10 is arranged so as to inject fuel directly into the combustion chamber of the diesel engine (not shown). Thus, high-pressure fuel fed from the common rail 40 is injected and fed directly into the combustion chamber in the engine cylinder (as direct injection feed). Next, the valve interior structure on the rear end side of the nozzle portion (injection portion) 10, namely, the internal structure of the valve body portion 20 will be described by chiefly referring to FIG. 1 again.

The valve body portion 20 includes a command piston 26 in synchronization with the nozzle needle 12, in the space F within the housing 21. The piston 26 is in the shape of a column being larger in diameter than the needle 12, and similar to the needle 12, it is slidden in its axial direction while being guided by a housing wall surface which defines the space F. Besides, on the valve rear end side (upper side in FIG. 1) of the piston 26 in the space F, a command chamber Fc which is defined by the housing wall surface and the top surface of the piston 26 is formed as part of the space F. High-pressure fuel from the common rail 40 flows into the command chamber Fc through the inlet orifice 21g.

The needle 12 and the piston 26 are connected by a pressure pin 22 (connecting shaft) which passes through the space E and the hole 21d in the axial direction. The pin 22 penetrates through the inside of the coil of a spring 23 (coiled spring) which is accommodated in the space E. In addition, the spring 23 has one end attached on the wall surface of the partition plate 21b and the other end attached on the rear end surface of the needle 12, and the needle 12 is urged toward the valve front end by the extensional force of the spring 23.

Besides, a stopper 24 by which the displacement of the needle 12 toward the valve rear end (lift-off side of the valve) is hindered at a predetermined position is also formed in the space E. The stopper 24 is formed integrally with the housing wall surface, and the rear end surface of the needle 12 abuts against the stopper 24 while the needle 12 is being lifted and cannot proceed any further. That is, the maximum lift quantity of the needle 12, and consequently, the position (limitation position) of the needle 12 in a maximum lift (full lift-off of the valve) are determined by the formation position of the stopper 24. The position (limitation position) of the needle 12 at the minimum lift is the needle position at the time when the cross-sectional area of the path between the accommodation portion D and the injection chamber B is set at “0” (the path is cut off), that is, when the needle 12 stops in abutment on the inner wall surface of the nozzle body 11 (when the needle 12 is seated). The movable range of the needle 12 is between both the limitation positions (maximum and minimum lift positions).

The actuation portion 30 includes a two-way valve (TWV) which is configured of an outer valve 32, a spring 33 (coiled spring) and a solenoid 34, in the space G within the housing 31. In a (deenergized) state where the two-way valve is not energized, the outer valve 32 is urged in a direction in which a fuel outflow port for the command chamber Fc, namely, the outlet orifice 31b is closed, by the extensional force of the spring 33 (extensional force along the axial direction). On the other hand, when the solenoid 34 of the two-way valve is energized (the solenoid 34 is magnetized), the outer valve 32 is attracted by the magnetic force of the solenoid 34 against the extensional force of the spring 33, and is displaced toward a side on which the outlet orifice 31b is opened. In this injection valve, by forming a fuel pressure circuit based on such actuation of the two-way valve over the command chamber Fc, the lift quantity of the needle 12 is controlled. in addition, a circuit for controlling the energization of the actuation portion 30, a program for performing an injection control through the circuit, etc. are installed in, for example, an ECU (electronic control unit) for an engine control, or an ECU for a fuel injection control, which is communicable with the ECU for the engine control.

The fuel injection apparatus of this embodiment controls the energization/deenergization of the two-way valve chiefly constituting the actuation portion 30, in binary fashion (through actuating pulses) by employing such an injection valve, to make variable the lift quantity of the nozzle needle 12 by an energization time period. Then, high-pressure fuel sequentially fed from the common rail 40 into the accommodation portion D through the fuel passage 21f is finally injected into the outer side A (FIG. 2) of the valve through the seat portion C (FIG. 2), injection chamber B and nozzle holes 11b in this order. On this occasion, fuel is basically led to the nozzle holes 11b by gravitation.

More specifically, in the apparatus, when the two-way valve (more specifically, the solenoid 34) is in the deenergized (OFF) state, the outer valve 32 descends toward the valve front end and closes the outlet orifice 31b. In this state when high-pressure fuel is fed from the common rail 40 into the injection chamber B through the fuel passage 21f and into the command chamber Fc through the inlet orifice 21g, both the pressures of the injection chamber B and the command chamber Fc become equal to a rail pressure, and force is applied to the command piston 26, which is larger in diameter than the lower part of the needle 12, in a direction of the valve front end, on the basis of a difference between the pressure receiving areas of the command piston 26 and the lower part of the needle 12. Thus, the piston 26 is pushed down toward the valve front end, and the needle 12 urged toward the valve front end by the spring 23 cuts off the fuel feed path extending from the common rail 40 to the nozzle holes 11b, at the part between the accommodation portion D and the injection chamber B, that is, at the seat portion C (FIG. 2) (as a needle seated state). During the deenergization, therefore, the injection of fuel is not performed (the valve is normally closed). Besides, surplus fuel under the piston 26 (for example, leakage fuel from the needle slide portion) is returned into the fuel tank through the leakage passage 21e and the return hole 31c.

On the other hand, during the energization (ON), the outer valve 32 is attracted toward the valve rear end by the magnetic force of the solenoid 34, thereby to open the outlet orifice 31b. When the outlet orifice 31b is opened, fuel in the command chamber Fc flows out into the fuel tank and under the piston 26, through the outlet orifice 31b, return hole 31c and leakage passage 21e, and pressure of the command chamber Fc, consequently, force to push down the piston 26 is lowered by the outflow of fuel. Accordingly, the piston 26 is pushed up toward the valve rear end, together with the needle 12 connected integrally. When the needle 12 is pushed up (when the valve is lifted off), the needle 12 is separated from the tapered oblique surface 11c and the fuel feed path leading to the nozzle holes 11b is opened at the seat portion C (FIG. 2). High-pressure fuel is fed into the injection chamber B through the seat portion C, and the fed fuel is injected and fed into the outer side A of the valve, namely, into the combustion chamber of the diesel engine through the nozzle holes 11b. In the apparatus, the cross-sectional area of the part (seat portion C) of the fuel feed path is made variable in accordance with the lift quantity of the needle 12, and a flowing speed of fuel flowing in the nozzle holes 11b, eventually, an injection ratio (quantity of fuel injected per unit time) is also made variable in accordance with the cross-sectional area. Accordingly, the injection ratio and the injection quantity can be controlled by variably controlling the parameters (energization time period and fuel pressure) which concern the lift quantity of the needle 12.

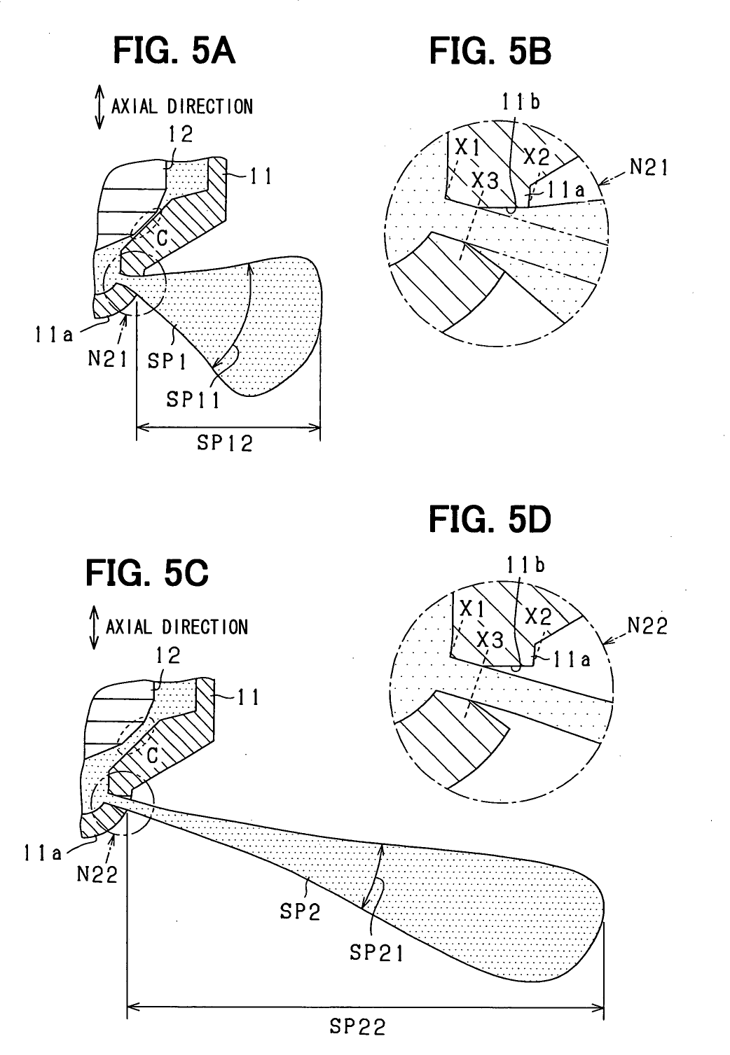

Next, manners in which fuel is injected in the fuel injection apparatus according to this invention will be detailed with reference to FIGS. 5A to 7B.

FIGS. 5A to 5D are illustrative view showing the shapes (injection shapes) of fuel which is injected from the injection valve according to this embodiment.

As shown in FIGS. 5A and 5B, when the needle 12 is lifted a small amount up, fuel flows through the nozzle hole 11b from the inlet toward the outlet of the nozzle hole 11b, and flows along the wall surface of the nozzle hole 11b to the nozzle hole outlet end X2. The shape of a spray SP1 which is injected from the injection valve corresponds to the nozzle hole shape (especially, the hole inner wall surface in contact with fuel) at a separation position, namely, the nozzle hole outlet end X2. Therefore, as shown in FIG. 5A, the spray SP1 in this case a wide spraying angle SP11 and a short spraying length SP12 corresponding to a penetration.

On the other hand, when the needle 12 is lifted a large amount up as shown in FIGS. 5C, 5D, the flowing speed of fuel becomes higher than in the case of the small lift, with the increase of the cross-sectional area of the seat portion C. Fuel flowing through the nozzle hole 11b cannot decrease its flowing speed (or change its direction) and separates from the hole wall surface, at the position (changing point X3) at which the cross-sectional area of the nozzle hole 11b changes (the area increases when viewed from the nozzle hole inlet side). In this case, accordingly, the shape of a spray SP2 injected from the injection valve conforms to the wall surface of the straight bore P (FIGS. 3A, 3B). As shown in FIG. 5C, a spraying angle SP21 becomes narrower than the spraying angle SP11, and a spraying length SP22 becomes larger than the spraying length SP12.

In this manner, in the fuel injection apparatus (injection valve) according to this embodiment, the separation position (at which of the nozzle hole outlet end X2 and the changing point X3 fuel separates), and eventually, the injection shape of fuel are made variable in accordance with the magnitude of the flowing speed of fuel which flows through the nozzle hole.

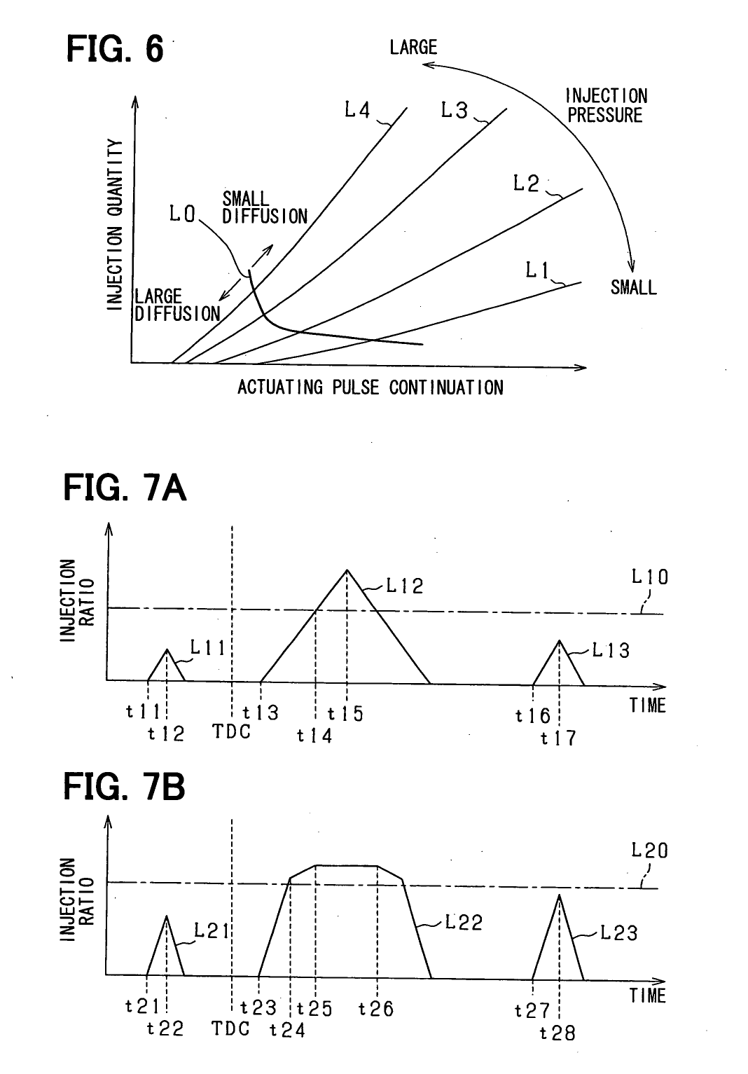

FIG. 6 is a graph showing the injection characteristics of the fuel injection apparatus (injection valve) according to this embodiment, and it illustrates a relationship between an actuating pulse continuation and an injection quantity, as to each of four sorts of injection pressures (characteristic lines L1-L4). The characteristic lines L1-L4 indicate the injection characteristics of the injection pressures different from one another. The characteristic line L1 indicates the injection characteristic at the time when the injection pressure is the smallest, and the injection pressures increase in the order of the characteristic lines L2, L3 and L4.

As shown in FIG. 6, the fuel injection quantity from the injection valve becomes larger as the actuating pulse continuation (energization time period) for the injection valve (solenoid 34 in FIG. 1) becomes longer. In a region where the actuating pulse continuation is shorter than a boundary line L0, the injection of fuel is performed in a manner of the spray SP1 as shown in FIG. 5A. When the actuating pulse continuation lengthens to exceed the boundary line L0, the injection of fuel is performed in a manner of the spray SP2 as shown in FIG. 5C. In addition, a boundary time period indicated by the boundary line L0, that is, the actuating pulse continuation at which the spraying shapes are changed-over becomes shorter for the larger injection pressure.

Besides, FIGS. 7A, 7B are timing charts each showing one aspect of fuel injection patterns, and especially the transition of an injection ratio in the vicinity of a TDC (top dead center). Additionally, such a fuel injection pattern is not fixed, but ordinarily, the optimum pattern is sequentially set on the basis of an engine running state (for example, a required torque value or an engine revolution speed), on each occasion, with reference to a map or the like.

As shown in each of FIGS. 7A, 7B, a plurality of times of fuel injections (multi-stage injections) are performed for one time of combustion in the illustrated example. More specifically, a small quantity of fuel is first injected as a pilot injection (L11, L21). Accordingly, the mixing of fuel and air immediately before ignition is promoted, and the delay of an ignition timing is shortened, thereby to restrict the production of NOₓ and to reduce combustion noise and vibrations. After the pilot injection (for example, immediately after the TDC), fuel injection whose injection quantity is larger than in the pilot injection, that is, a main injection for generating output torque (L12, L22) is performed. Further, a post-injection (L13, L23) whose injection quantity is smaller than in the main injection and larger than in the pilot injection is performed at a timing which is a predetermined time period later than the main injection, after a certain interval whereby the combustion by the main injection is continued. Consequently, non-combusted fuel (mainly HC) is added to the oxidizing catalyst of a DPF (Diesel Particulate Filter) disposed in an exhaust system, thereby to burn the collected PM of the DPF by the resulting reaction heat (heat generated by an oxidizing reaction), and eventually to regenerate the DPF.

More specifically, in the case of the injection pattern shown in FIG. 7A, the injection valve is first energized from a timing t11 to a timing t12 in order to perform the pilot injection. The needle 12 is lifted up during the energization. Meanwhile, the injection ratio increases in accordance with how much the needle 12 is lifted up. That is, during the energization, the injection ratio increases in proportion to the energization time period (actuating pulse continuation). Thereafter, when the energization is stopped at the timing t12, the needle 12 descends gradually, and also the injection ratio lowers gradually in conformity with the lift quantity of the needle 12. In this injection period here, even the maximum injection ratio does not exceed a boundary injection ratio corresponding to the boundary line L0 (FIG. 6) (an injection ratio indicated by a boundary line L10 in FIG. 7A), that is, the injection ratio at which the spraying shapes are changed-over. With this injection, accordingly, fuel is always injected in a manner of the spray SP1 as shown in FIG. 5A.

Subsequently, in order to perform the main injection, the injection valve is energized from a timing t13 to a timing t15. In this case as well, the injection ratio increases in accordance with the lift quantity of the needle 12, and it begins to lower simultaneously with the stop of the energization. In this case, however, at a timing t14 before the timing t15 is reached, the injection ratio exceeds the value of the boundary line L10, and the spraying shapes are changed-over from the spray SP1 in FIG. 5A, to the spray SP2 in FIG. 5C. Accordingly, the main injection is performed with the spray of the narrow spraying angle and the large spraying length.

After the main injection, the injection valve is energized from a timing t16 to a timing t17, thereby to perform the post-injection.

On the other hand, the injection pattern shown in FIG. 7B is basically the same as in the case of FIG. 7A. That is, timings t21, t22, t27, t28 correspond to the timings t11, t12, t16, t17, respectively. In this case, however, the injection ratio is saturated in the main injection as shown in FIG. 7B. More specifically, the injection valve is energized from a timing t23 to a timing t26, and the injection ratio increases in accordance with the lift quantity of the needle 12 during the energization. At a timing t24, the injection ratio exceeds the value of a boundary line L20 (boundary injection ratio), and the spraying shapes are changed-over. Thereafter, the injection ratio is saturated at a timing t25. This is because an injection ratio limitation (an upper limit of the injection ratio) is set on the basis of, for example, arrival at the maximum lift (the lift of the needle 12 is regulated by the stopper 24 in FIG. 1), and the shape of the nozzle holes 11b (e.g., the cross-sectional area).

In this manner, in both the cases of FIGS. 7A, 7B, the pilot injection and the post-injection (sub injections) are performed with the sprays (FIG. 5A) of wide spraying angle and small spraying length, and the main injection is performed with the spray (FIG. 5C) of narrow spraying angle and large spraying length.

Here, the sub injections which are performed before and after the main injection serve strictly as injections subsidiary to the main injection, and thus the smaller quantities of fuel than in the main injection are injected to serve to become the origin of the combustion by the main injection, and to continue the combustion. In addition, ordinarily, such sub injections may preferably be performed at a part which is near to an ignition position within the combustion chamber. On the other hand, ordinarily, the main injection for generating the output torque may preferably be performed so as to reach a far position at a high fuel density. In this regard, by employing the fuel injection pattern as shown in FIG. 7A or 7B, fuel is injected with the spray as shown in FIG. 5A (the spray of wide spraying angle and small spraying length) in the case of each sub injection, whereby the considerable spray can be formed concentratively in the vicinity of the ignition position. Furthermore, in the case of the main injection, fuel is injected with the spray as shown in FIG. 5C (the spray of narrow spraying angle and large spraying length), whereby the spray which reaches the far position at the high fuel density can be formed. In this manner, according to the fuel injection apparatus of this embodiment, favorable combustion characteristics are attained as the combustion characteristics of the diesel engine for use in, for example, an automobile.

According to this embodiment detailed above, excellent advantages to be stated below are brought forth.

(1) As the fuel injection apparatus in which fuel fed to the nozzle portion 10 (injection portion) is injected through nozzle holes 11b, each nozzle hole 11b is formed to have a nozzle hole outlet region X2-X3 (tapered bore T) whose cross-sectional area becomes smaller continuously from the nozzle hole outlet end X2 toward the nozzle hole inlet (FIGS. 3A, 3B). Thus, by variably controlling the magnitude of the flowing speed of fuel flowing through the nozzle hole, the spraying shape of fuel can be easily controlled.

(2) The nozzle hole 11b is formed to have a shape in which, regarding where from the nozzle hole inlet (nozzle hole inlet end X1) to the nozzle hole outlet (nozzle hole outlet end X2) fuel flowing through the hole from the nozzle hole inlet toward the nozzle hole outlet separates from a hole wall surface, a separation position from the hole wall surface is made variable, depending upon the magnitude of the flowing speed of the fuel (FIGS. 3A to 5D). Thus, by variably controlling the magnitude of the flowing speed of fuel flowing through the nozzle hole, the spraying shape of the fuel can be easily controlled.

(3) The nozzle hole 11b is formed to have a shape in which, regarding whether fuel flowing through the nozzle hole from the nozzle hole inlet (nozzle hole inlet end X1) toward the nozzle hole outlet (nozzle hole outlet end X2) separates from the hole wall surface, at the nozzle hole outlet end X2 or on an upstream side of the nozzle hole outlet end X2 (at the changing point X3), either of these separation positions can be selected, depending upon the magnitude of the flowing speed of the fuel (FIGS. 3A to 5D). Thus, by variably controlling the magnitude of the flowing speed of fuel flowing through the nozzle hole, the spraying shape of the fuel can be easily controlled.

(4) The nozzle hole 11b is formed to have one point (the changing point X3) other than the nozzle hole inlet end and the nozzle hole outlet end, as a separation point at which fuel flowing through the hole becomes easy of separating from the hole wall surface by increasing its flowing speed (FIGS. 3A to 5D). Owing to the provision of such a separation point (the changing point X3), the choices of the spraying shape of fuel are widened, and eventually, the spraying shape can be made variable at a higher degree of flexibility.

(5) The changing point X3 as the separation point is formed by sharply changing a change ratio of the cross-sectional area of the nozzle hole 11b. Thus, the separation point can be easily formed.

(6) the linear straight bore P (nozzle hole straight portion) which has a constant cross-sectional area in its axial direction is provided as means for intensifying the directivity of the fuel in the flowing direction thereof (directivity enhancement means), at part (X1-X3) of the nozzle hole 11b on a fuel upstream side of the region X2-X3 (nozzle hole outlet region) (FIGS. 3A, 3B). Easiness in the separation of fuel is also influenced by the flowing direction of the fuel. More specifically, when the directivity of fuel flowing into the nozzle hole outlet region is low (fuel flows in scattering directions), how to separate becomes nonuniform, and the irregular variations of the spraying shape and the worsening of the controllability thereof might be incurred. In this regard, when the directivity enhancement means is provided on the fuel upstream side of the nozzle hole outlet region (e.g., before the nozzle hole or at the intermediate position of the nozzle hole), fuel is separated more orderly and regularly in accordance with a high directivity, and eventually, a fuel injection apparatus of excellent spraying characteristic and high controllability can be incarnated. Thus, the fuel injection apparatus of excellent spraying characteristic and high controllability can be realized.

(7) Moreover, the straight bore P as the part of the nozzle hole 11b is employed as the means for intensifying the directivity (directivity enhancement means), whereby the directivity of fuel in the flowing direction thereof can be easily intensified merely by the shape of the nozzle hole 11b.

(8) The region X2-X3 (nozzle hole outlet region) is formed of a cylindrical hole (tapered bore T) whose diameter is concentrically reduced from the nozzle hole outlet side toward the nozzle hole inlet (FIGS. 3A, 3B). Thus, the manufacture of the apparatus (especially, the working of the nozzle hole) is facilitated, and the spraying shape of good quality is easily obtained.

(9) Further, regarding the shape of the whole nozzle hole 11b, the nozzle hole 11b is formed in a three-dimensional shape in which a point symmetry holds with a symmetry axis being the nozzle hole axis Y (a line that indicates the center axis of the nozzle hole from the inlet to the outlet of the nozzle hole), for each of individual sections of the nozzle hole 11b from the inlet to the outlet thereof (FIGS. 3A, 3B), so that the manufacture is more facilitated, and the spraying shape of good quality is obtained.

(10) There are provided the nozzle (nozzle portion 10) as an injection portion, and the nozzle needle 12 which is disposed in the nozzle, and by which the cross-sectional area of the fuel feed path for feeding fuel to each nozzle hole 11b is made variable at the seat portion C located upstream of the nozzle hole 11b. Thus, the flowing speed of fuel flowing through the nozzle hole 11b is made variable in accordance with the magnitude of the cross-sectional area of the fuel feed path at the seat portion C which is made variable by the needle 12. In a case where “βc” denotes the enlargement ratio of the cross-sectional area of the path from the seat portion C toward its lower stream, in a state in which the cross-sectional area of the seat portion C is minimized by the needle 12, and where “βf” denotes the enlargement ratio of the cross-sectional area of the path from the seat portion C toward its lower stream, in a state in which the cross-sectional area of the seat portion C is maximized by the needle 12, the enlargement ratio “β” of the region X2-X3 (nozzle hole outlet region) is set so as to satisfy the relationship of “βf<β<βc” (FIGS. 4A, 4B). Accordingly, the separation point can be easily formed where fuel does not separate when the cross-sectional area of the fuel feed path at the seat portion C is small (when the flowing speed of fuel flowing through the nozzle hole 11b is low), and where fuel separates when the cross-sectional area of the fuel feed path at the seat portion C is large (when the flowing speed of fuel flowing through the nozzle hole 11b is high). By forming such a separation point, the existence or nonexistence of the separation of fuel, and eventually, the spraying shape can be easily controlled, on the basis of the actuation of the needle 12 (the magnitude of a lift quantity).

(11) The inner wall of the nozzle at the seat portion C is formed in a tapered shape. The needle 12 is configured to have a seat surface (tapered oblique surface 12a) which opposes to the tapered nozzle inner wall (tapered oblique surface 11c) with the fuel feed path therebetween. By making variable the gap between the seat surface and the nozzle inner wall by the needle 12, the cross-sectional area of the fuel feed path is made variable. With the fuel injection apparatus of such a type, the position (lift quantity) of the needle 12 is controlled, whereby the flowing speed of fuel flowing through the nozzle hole 11b can be variably controlled in accordance with the cross-sectional area at the seat portion C.

(12) This fuel injection apparatus is configured as a fuel injection apparatus for a diesel engine, which is used for feeding fuel to the diesel engine in a high-pressure injection system (common-rail system). Meanwhile, in a gasoline engine, there has been known a technique wherein fuel turned into bubbles is caused to collide before a nozzle hole, thereby to separate the fuel from a hole wall surface at the inlet end of the nozzle hole and to promote the atomization of the injection fuel. In a fuel injection apparatus adopting such a technique, a spray which is injected through the nozzle hole contains, not only a liquid column-shaped part, but also a part brought into a liquid film shape by a pressure from an embraced gas. As understood from the fact that such a technique has been known, gasoline is fuel which has the property of easily separating from the hole wall surface, and it is liable to form a liquid film-shaped region in the spray. In addition, such properties of the gasoline act as unfavorable factors in case of realizing the invention, such as separating fuel at the inlet end of the nozzle hole irrespective of the cross-sectional area of the nozzle hole as stated above. In the gasoline engine, therefore, the condition of making the spraying shape of fuel variable through the selection of the separation point becomes severe, and a restriction concerning the design of, for example, an apparatus structure (e.g., nozzle structure) becomes serious. In view of the properties of light oil which the diesel engine employs as fuel and which is relatively not liable to separate, light oil is easily flowed along the hole wall surface in the injection region of small injection ratio (low fuel flowing speed), and eventually, a degree of flexibility in the design of an apparatus structure (e.g., nozzle structure) can be kept high.

(13) The injection portion (nozzle portion 10) is arranged so as to inject fuel directly into the combustion chamber of the engine. A program (injection control means) for controlling the flowing speed of fuel flowing through the nozzle hole 11b is installed so that, in the high-injection-ratio region of a main injection (region where the injection ratio is higher than an injection ratio indicated by the boundary line L10 in FIG. 7A or L20 in FIG. 7B), fuel is separated at a position (changing point X3) which is smaller in the cross-sectional area than at the separation position (nozzle hole outlet end X2) in the high-injection-ratio region of a sub injection (pilot injection or post-injection). Consequently, favorable combustion characteristics are attained as the combustion characteristics of the diesel engine for use in, for example, an automobile. In addition, although the program is employed here, the same function may be realized by a dedicated circuit or the like.

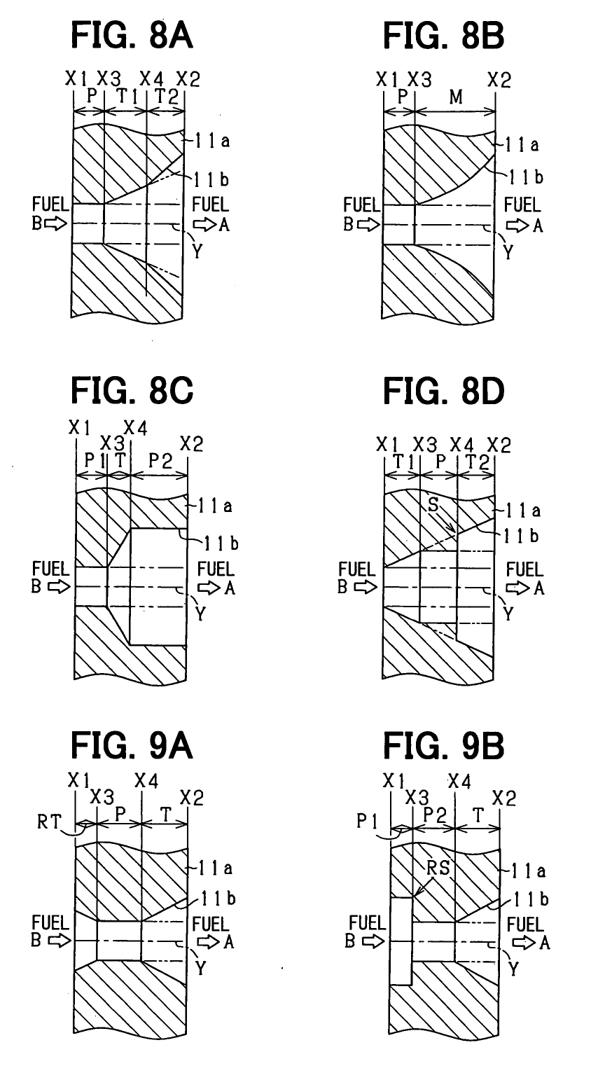

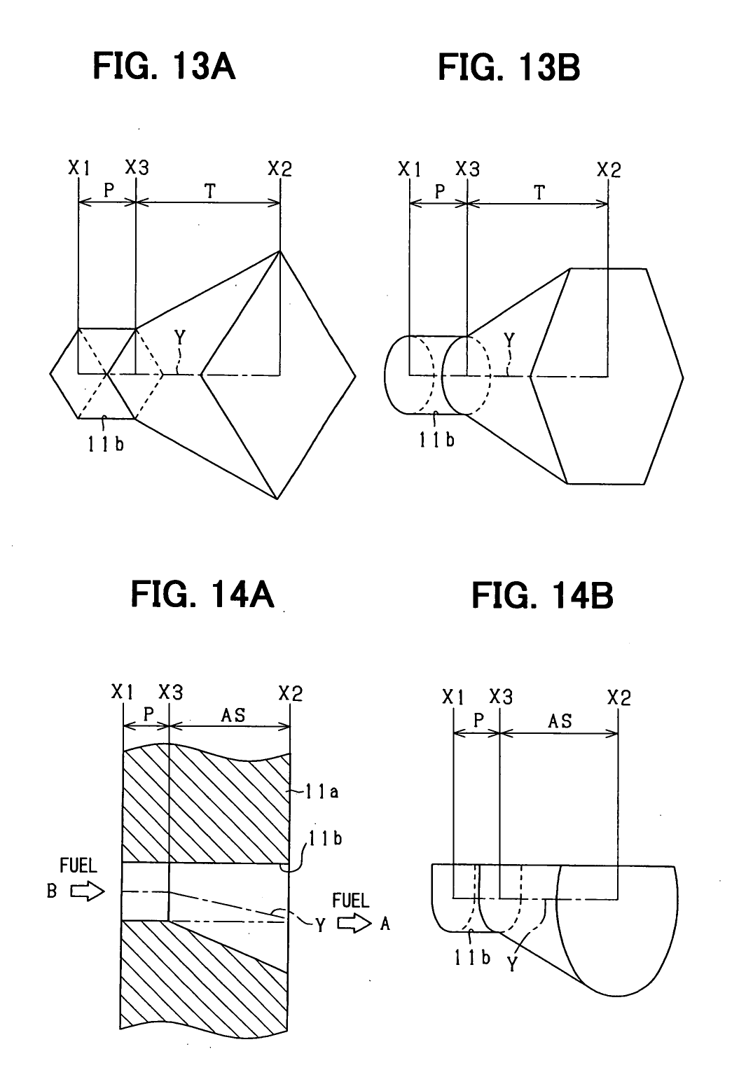

The present invention is not restricted to the described contents of the embodiment, but it may be performed as stated below by way of example.
The embodiment has referred to the case where the invention is applied to the solenoid injector by way of example, but the invention is applicable also to an injection valve of another type, for example, a piezo-injector which is actuated by a piezo-actuator, basically in the same manner. In addition, the same advantage as the above advantage (12) or an advantage similar thereto can be attained in, at least, the fuel injection apparatus for a diesel engine.
The use in the diesel engine is not an indispensable condition, but the invention is applicable also to a fuel injection apparatus for use in any other engine than the diesel engine. The invention is meritorious also in, for example, a direct fuel-injection gasoline engine.
The number of the nozzle holes and the size of each nozzle hole are as desired, and the invention is not restricted to the fuel injection valve of multihole type, but it is applicable also to a fuel injection valve of single hole type.
Regarding the stopper which determines the movable range of the needle, a member (e.g., the stopper 24) for mechanically regulating the movement of the needle is not restrictive, but a member of any desired scheme can be adopted. It is also allowed to adopt, for example, a member which regulates the movement of the needle by a pressure balance. Since, however, the stopper is not an indispensable constituent, it may be omitted when not especially required.
The shape of the nozzle hole 11b as a fuel injection nozzle is not restricted to one shown in FIGS. 3A, 3B. Insofar as a nozzle hole has a nozzle hole outlet region whose cross-sectional area becomes smaller continuously or stepwise from the nozzle hole outlet end toward the nozzle hole inlet, the application of the invention is possible, and at least the intended object is accomplished, even if the shape is appropriately altered within the scope. Now, examples of nozzle hole shapes different from the shape shown in FIGS. 3A, 3B (modifications of nozzle hole shapes) will be described with reference to FIGS. 8A to 14B. In addition, FIGS. 8A to 12 and FIG. 14A are sectional views each corresponding to FIG. 3A, and FIGS. 13A, 13B and FIG. 14B are illustrative views each corresponding to FIG. 3B. The shapes exemplified in FIGS. 8A to 13B among them are three-dimensional shapes of high symmetry in each of which, as in the shape shown in FIGS. 3A, 3B, the point symmetry holds with the symmetry axis being the nozzle hole axis Y, for each of the sections of the region X1-X2 of the whole hole.

It is possible to adopt the shape as shown in FIG. 8A, in which the reduction ratio of the cross-sectional area in the nozzle hole outlet region becomes smaller stepwise (in, for example, one step or more steps) from the nozzle hole outlet side toward the nozzle hole inlet. By the way, in the example shown in FIG. 8A, a tapered bore T1 (region X3-X4) and a tapered bore T2 (region X4-X2) of different taper angles from each other are provided in continuation to the outlet side of the straight bore P (region X1-X3), and the reduction ratio of the cross-sectional area in the nozzle hole outlet region (region X2-X3) becomes smaller stepwise (at a changing point X4) from the nozzle hole outlet end X2 toward the nozzle hole inlet (T1<T2 for the taper angle). Accordingly, the separation point can be easily formed at the position (changing point X4) at which the reduction ratio of the cross-sectional area becomes smaller. In this manner, by providing the nozzle hole with the separation point in addition to the nozzle hole inlet end and the nozzle hole outlet end, the choices of the spraying shape of fuel are widened, and eventually, the spraying shape can be varied with a higher degree of flexibility. Besides, in case of the configuration having the plurality of tapered bores of different taper angles in this manner, at least one taper angle is set so as to satisfy the relationship of “βf<β<βc”, whereby the same advantage as the advantage (10) or an advantage similar thereto can be attained.

It is possible to adopt the shape as shown in FIG. 8B, in which the reduction ratio of the cross-sectional area in the nozzle hole outlet region becomes smaller continuously from the nozzle hole outlet side toward the nozzle hole inlet. The flowing speed needs to be sharply lowered, and the direction needs to be greatly changed, in order that fuel continues to flow along the hole wall surface especially at a position where the change ratio of the cross-sectional area (the enlargement ratio of the cross-sectional area when viewed from the nozzle hole inlet side) is large in the nozzle hole. In the nozzle hole outlet region, accordingly, the separation of fuel from the hole wall surface is liable to occur, especially at the position where the change ratio (enlargement ratio) of the cross-sectional area is large. Therefore, with the above configuration in which the reduction ratio becomes smaller from the nozzle hole outlet side toward the nozzle hole inlet, in other words, in which the enlargement ratio becomes larger from the nozzle hole inlet side toward the nozzle hole outlet, the position of the separation from the hole wall surface, and eventually, the spraying shape of fuel can be varied with a higher degree of flexibility based on the magnitude of the flowing speed of fuel flowing through the nozzle hole. By the way, in the example shown in FIG. 8B, a curved hole M (region X3-X2) in which the reduction ratio of the cross-sectional area in the nozzle hole outlet region (region X2-X3) becomes smaller continuously (steplessly) toward the nozzle hole inlet is provided in continuation to the outlet side of the straight bore P (region X1-X3). As a result, the position of the separation from the hole wall surface, and eventually, the spraying shape of fuel can be varied with a higher degree of flexibility, on the basis of the magnitude of the flowing speed of fuel flowing through the nozzle hole 11b.

As shown in FIG. 8C, the nozzle hole 11b may be configured so as to properly use a plurality of sorts (e.g., two sorts) of sprays whose spraying angles are identical. By the way, in the example shown in FIG. 8C, on the outlet side of the straight bore P1 (region X1-X3), the other straight bore P2 (region X4-X2) is further provided with a tapered bore T (region X3-X4) interposed therebetween, and the cross-sectional area of the region X2-X3 (nozzle hole outlet region) becomes smaller stepwise from the nozzle hole outlet end X2 toward the nozzle hole inlet (P1<P2 for the cross-sectional area). Besides, in this example, the two sorts of sprays whose spraying widths at the injections (separations) are different (in correspondence with the cross-sectional areas at changing points X3, X4 can be properly used, and the spraying length (penetration) changes in correspondence with the difference of the spraying widths, whereby an advantage similar to the advantage (13) can be attained.

It is possible to adopt the shape as shown in FIG. 8D, in which the end portion of the nozzle hole outlet region is provided with a step portion S that enlarges the cross-sectional area of the nozzle hole 11b in a direction toward the outer side of the hole, the direction being perpendicular to the nozzle hole axis Y of the nozzle hole 11b. By the way, in the example shown in FIG. 8D, on the outlet side of a tapered bore T1 (region X1-X3), another tapered bore T2 (region X4-X2) is further provided with the straight bore P (region X3-X4) interposed therebetween, and the step portion S is formed at the changing point X4 corresponding to the end portion of the nozzle hole outlet region (region X2-X4). That is, in this example, the straight bore P provided midway of the nozzle hole 11b acts to intensify directivity, and the region X2-X4 located on the fuel downstream side (nozzle hole outlet side) of the straight bore P corresponds to the nozzle hole outlet region. According to such a step portion S, a separation point, at which fuel flowing through the nozzle hole 11b is separated from the hole wall surface more reliably, can be formed.

As shown in FIGS. 9A, 9B, even when the nozzle hole inlet side of the nozzle hole 11b is worked at will, the same advantages as the foregoing advantages or advantages similar thereto can be attained as long as the nozzle hole outlet region is formed on the nozzle hole outlet side. By the way, in the example shown in FIG. 9A, a reverse tapered bore RT (region X1-X3) which reduces the diameter of the hole toward the outlet, reversely to a tapered bore T is formed on the nozzle hole inlet side, and the straight bore P (region X3-X4) and the tapered bore T (region X4-X2) are successively provided in continuation to the outlet side of the reverse tapered bore RT. Besides, in the example shown in FIG. 9B, a straight bore P1 is formed on the nozzle hole inlet side, and a straight bore P2 (region X3-X4) and the tapered bore T (region X4-X2) are successively provided on the outlet side of the straight bore P1 with a reverse step portion RS, which reduces the diameter of the hole in a direction toward the inner side of the hole reversely to the step portion S, interposed therebetween. In either example, the region X2-X3 corresponds to the nozzle hole outlet region.

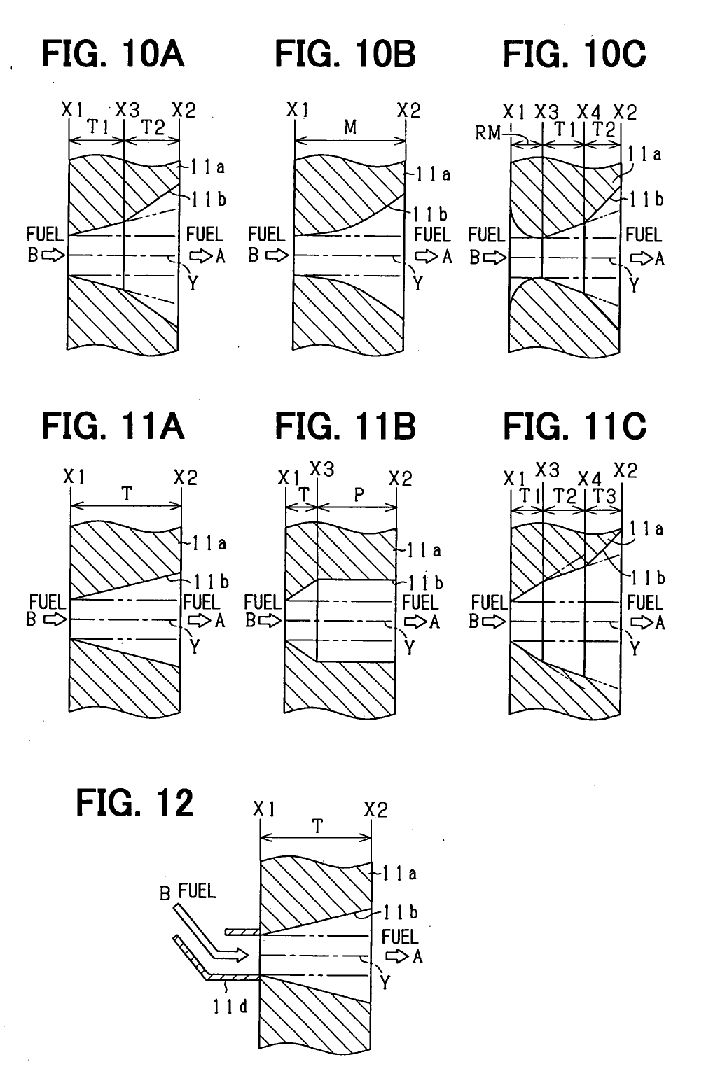

Unlike the straight bore P having a constant cross-sectional area in the axial direction of the nozzle hole 11b, a hole having a substantially constant cross-sectional area in the axial direction (a region whose cross-sectional area in the axial direction is nearly constant) as shown in FIGS. 10A to 10C can intensify a directivity instead of the straight bore P. In this case, accordingly, an advantage similar to the advantage (6) or (7) can be attained. By the way, in the example shown in FIG. 10A, in continuation to the outlet side of a tapered bore T1 (region X1-X3) of small taper angle, a tapered bore T2 (region X3-X2) whose taper angle is larger than in the tapered bore T1 is provided. Besides, in the example shown in FIG. 10B, the nozzle hole 11b is formed by a curved hole M (region X1-X2) whose change ratio (reduction ratio of the cross-sectional area) is small near the nozzle hole inlet end X1. Incidentally, in each of the cases of FIGS. 10A, 10B, the region X2-X1 corresponds to the nozzle hole outlet region. Besides, in the example shown in FIG. 10C, in continuation to the outlet side of a reverse curved hole RM (region X1-X3) which makes the reduction ratio of the cross-sectional area smaller continuously toward the outlet, reversely to the curved hole M, a tapered bore T1 (region X3-X4) and a tapered bore T2 (region X4-X2) of different taper angles from each other are provided (T1<T2 for the taper angle). Besides, in this case, the region X2-X3 corresponds to the nozzle hole outlet region. However, in order to reliably intensify a directivity in an intended direction, the directivity of fuel may more preferably be enhanced using the straight bore P which makes the cross-sectional area constant in the axial direction of the nozzle hole 11b as in the shape shown in FIGS. 3A, 3B.

It is not an indispensable configuration that such a means for intensifying the directivity is provided on the fuel upstream side of the nozzle hole outlet region. Depending upon, for example, the structure of the injection valve, the nozzle hole 11b may be shaped without forming such means, as shown in each of FIGS. 11A to 11C. By the way, in the example shown in FIG. 11A, the nozzle hole 11b is formed by a tapered bore T (region X1-X2). In the example shown in FIG. 11B, the straight bore P (region X3-X2) is provided in continuation to the outlet side of the tapered bore T (region X1-X3). Incidentally, in each of the cases of FIGS. 11A, 11B, the region X2-X1 corresponds to the nozzle hole outlet region. Besides, in the example shown in FIG. 11C, a plurality of tapered bores of different taper angles; a tapered bore T1 (region X1-X3), a tapered bore T2 (region X3-X4) and a tapered bore T3 (region X4-X2) are successively provided from the nozzle hole inlet side, and the reduction ratio of the cross-sectional area of the nozzle hole outlet region (region X2-X3) becomes smaller stepwise (at a changing point X4) from the nozzle hole outlet end X2 toward the nozzle hole inlet (T1>T2<T3 for the taper angle).

Besides, a member for intensifying a directivity may be provided separately from the nozzle hole 11b, without being provided in the nozzle hole 11b itself. As shown in FIG. 12 by way of example, a directivity enhancement member 11d (e.g., a tube or a plate) which lead a fuel flow into the nozzle hole 11b while intensifying the directivity in one predetermined direction (e.g., in a direction perpendicular to the inlet wall surface of the nozzle hole 11b) is adopted, and it is provided before the nozzle hole 11b (on a fuel upstream side of 11b). As a result, an advantage similar to the advantage (6) is attained. In addition, such a configuration is especially effective when adopted for the nozzle hole 11b which has the configuration with the straight bore P omitted (e.g., the configuration of FIG. 11A), as in the example shown in FIG. 12.

Besides, although the columnar holes have been supposed thus far, they are not restrictive, but as shown in FIGS. 13A, 13B, the nozzle hole 11b may be formed as a hole in a polygonal pillar shape or as a hole in a shape in which a columnar part and a polygonal pillar-shaped part are combined. By the way, FIG. 13A shows an example which adopts a square pillar-shaped hole, and FIG. 13B shows an example which adopts a hole in a shape having a columnar part (region X1-X3) and a hexagonal pillar-shaped part (region X3-X2) in combination.

It is also possible to adopt a shape which is asymmetric with respect to the nozzle hole axis Y as shown in FIGS. 14A, 14B. In the example shown in FIGS. 14A, 14B, in continuation to the outlet side of the straight bore P (region X1-X3), a single-sided tapered bore AS (region X3-X2) in which one side is linear and in which only a side wall on the other side is tapered and worked asymmetrically is provided. Also in this case, a separation point is formed at the changing point X3 between the straight bore P and the single-sided tapered bore AS. Alternatively, any of an long columnar hole, an elliptic cylinder-shaped hole, etc. may be adopted.

Besides, any desired shape may be adopted by appropriately combining the tapered bore T, curved hole M, straight bore P, step portion S, reverse curved hole RM, reverse step portion RS, etc. In short, the nozzle hole may have the nozzle hole outlet region whose cross-sectional area becomes smaller continuously or stepwise from the nozzle hole outlet end toward the nozzle hole inlet.
Further, if machining technology and design technology are improved in the future to the extent that a nozzle hole of complicated shape can be precisely formed, a nozzle hole in a shape satisfying at least one of the following two conditions will become freely designable irrespective of the existence or nonexistence of the nozzle hole outlet region:
   “a shape whereby, regarding where from the nozzle hole inlet to the nozzle hole outlet fuel flowing through a nozzle hole from the inlet of the nozzle hole toward the outlet thereof separates from a hole wall surface, the position of the separation from the hole wall surface is made variable according to the magnitude of the flowing speed of the fuel”; and
   “a shape whereby, regarding whether fuel flowing through a nozzle hole from the inlet of the nozzle hole toward the outlet thereof separates from a hole wall surface at the outlet end of the nozzle hole or on an upstream side of the nozzle hole outlet end, either of the positions of the separation is able to be selected according to the magnitude of the flowing speed of the fuel”.

In this sense, even the formation of the nozzle hole outlet region is not an indispensable condition to the present invention, and the invention is also applicable to a configuration in which the nozzle hole outlet region is not formed.

Additional advantages and modifications will readily occur to those skilled in the art. The invention in its broader terms is therefore not limited to the specific details, representative apparatus, and illustrative examples shown and described.

What is claimed is:

1. A fuel injection apparatus comprising a nozzle portion, into which fuel flows, wherein:
the nozzle portion includes at least one nozzle hole;
fuel is injected through the at least one nozzle hole;
each of the at least one nozzle hole includes a nozzle hole outlet region; and
a cross-sectional area of the nozzle hole outlet region decreases one of continuously and stepwise in a direction opposite from a fuel flowing direction.

2. The fuel injection apparatus according to claim 1, wherein a reduction ratio of the cross-sectional area of the nozzle hole outlet region decreases continuously in the direction opposite from the fuel flowing direction.

3. The fuel injection apparatus according to claim 1, wherein a reduction ratio of the cross-sectional area of the nozzle hole outlet region decreases stepwise in the direction opposite from the fuel flowing direction.

4. The fuel injection apparatus according to claim 1, wherein the nozzle hole outlet region includes a step surface extending in a direction perpendicular to a nozzle hole axis of a corresponding one of the at least one nozzle hole, so that the cross-sectional area of the nozzle hole outlet region increases radially outward of the nozzle hole axis at the step surface.

5. The fuel injection apparatus according to claim 1, further comprising a directivity enhancement means for enhancing directivity in the fuel flowing direction, on an upstream side of the nozzle hole outlet region in the fuel flowing direction.

6. The fuel injection apparatus according to claim 5, wherein:
the directivity enhancement means includes a nozzle hole linear portion, which is linear and serves as a part of the corresponding one of the at least one nozzle hole; and
the nozzle hole linear portion has a cross-sectional area, which is generally constant along the nozzle hole axis.

7. The fuel injection apparatus according to claim 1, wherein the nozzle hole outlet region includes a columnar hole, a diameter of a cross-sectional surface of which is concentrically reduced in the direction opposite from the fuel flowing direction.

8. The fuel injection apparatus according to claim 1, wherein the each of the at least one nozzle hole has a three-dimensional shape, every cross section of which between an inlet and an outlet of the each of the at least one nozzle hole is point-symmetric with respect to the nozzle hole axis.

9. The fuel injection apparatus according to claim 1, further comprising:
a nozzle included in the nozzle portion, wherein the nozzle includes the at least one nozzle hole; and
a nozzle needle that is disposed inside the nozzle thereby to define a fuel supply route, through which fuel flows into the each of the at least one nozzle hole, between the nozzle needle and an inner wall surface of the nozzle and that changes a cross-sectional area of the fuel supply route at a seat portion located on an upstream side of the each of the at least one nozzle hole in the fuel flowing direction, to change a flowing speed of fuel flowing through the each of the at least one nozzle hole according to the cross-sectional area of the fuel supply route at the seat portion, wherein:
the nozzle hole outlet region includes at least one tapered hole;
each of the at least one tapered hole has a corresponding increase ratio, at which a cross-sectional area of the each of the at least one tapered hole increases in the fuel flowing direction; and
at least one of the corresponding increase ratio is larger than βf and smaller than βc, given:
βc, which is an increase ratio of the cross-sectional area of the fuel supply route in a direction from the seat portion toward a downstream side of the fuel supply route in the fuel flowing direction in a state where the cross-sectional area of the fuel supply route at the seat portion is minimized by the nozzle needle; and
βf, which is an increase ratio of the cross-sectional area of the fuel supply route in the direction from the seat portion toward the downstream side of the fuel supply route in the fuel flowing direction in a state where the cross-sectional area of the fuel supply route at the seat portion is maximized by the nozzle needle.

10. The fuel injection apparatus according to claim 9, wherein:
the inner wall surface is formed in a tapered shape at the seat portion;
the nozzle needle has a seat surface, which is opposed to the inner wall surface with the fuel supply route therebetween; and
the nozzle needle changes the cross-sectional area of the fuel supply route by changing a distance between the seat surface and the inner wall surface.

11. The fuel injection apparatus according to claim 1, further comprising:
a nozzle included in the nozzle portion, wherein the nozzle includes the at least one nozzle hole; and
a nozzle needle that is disposed inside the nozzle thereby to define a fuel supply route, through which fuel flows into the each of the at least one nozzle hole, between the nozzle needle and an inner wall surface of the nozzle and that changes a cross-sectional area of the fuel supply route at a seat portion located on an upstream side of the each of the at least one nozzle hole in the fuel flowing direction, wherein:
the inner wall surface is formed in a tapered shape at the seat portion;
the nozzle needle has a seat surface, which is opposed to the inner wall surface with the fuel supply route therebetween; and
the nozzle needle changes the cross-sectional area of the fuel supply route by changing a distance between the seat surface and the inner wall surface.

12. The fuel injection apparatus according to claim 1, wherein the fuel injection apparatus supplies fuel to a diesel engine.

13. The fuel injection apparatus according to claim 1, further comprising an injection control means for controlling the separation position by variably controlling the flowing speed of fuel flowing through the each of the at least one nozzle hole.

14. The fuel injection apparatus according to claim 13, wherein:
the nozzle portion is disposed to inject fuel directly into a combustion chamber of an engine;
the nozzle portion performs main fuel injection to generate output torque, and performs subordinate fuel injection by injecting an smaller injection quantity of fuel than the main fuel injection before or after performing the main fuel injection;
the injection control means controls the flowing speed of fuel such that at least in a state where an injection ratio of the main fuel injection is higher than a first predetermined injection ratio, fuel separates at a position, where the cross-sectional area of the each of the at least one nozzle hole is smaller than the cross-sectional area at the separation position when an injection ratio of the subordinate fuel injection is higher than a second predetermined injection ratio; and
a maximum injection ratio of the subordinate fuel injection is lower than the first predetermined injection ratio, and is higher than the second predetermined injection ratio.

15. A fuel injection apparatus comprising a nozzle portion, into which fuel flows, wherein:
the nozzle portion includes at least one nozzle hole;
fuel is injected through the at least one nozzle hole;
each of the at least one nozzle hole is configured such that a separation position located between an inlet and outlet end portion of the each of the at least one nozzle hole is variable according to a flowing speed of fuel; and
at the separation position, fuel separates from a wall surface of the each of the at least one nozzle hole while flowing from the inlet end portion to the outlet end portion of the each of the at least one nozzle hole.

16. The fuel injection apparatus according to claim 15, wherein:
the each of the at least one nozzle hole has a plurality of separation points;
at each of the plurality of separation points, fuel flowing from the inlet end portion to the outlet end portion of the each of the at least one nozzle hole separates from the wall surface of the each of the at least one nozzle hole more easily when the flowing speed of fuel increases; and
the plurality of separation points includes the inlet end portion and the outlet end portion of the each of the at least one nozzle hole, and at least one position located between the inlet and outlet end portion of the each of the at least one nozzle hole.

17. The fuel injection apparatus according to claim 16, wherein the plurality of separation points is formed by sharply changing a changing rate of a cross-sectional area of the each of the at least one nozzle hole.

18. The fuel injection apparatus according to claim 15, further comprising:
a nozzle included in the nozzle portion, wherein the nozzle includes the at least one nozzle hole; and
a nozzle needle that is disposed inside the nozzle thereby to define a fuel supply route, through which fuel flows into the each of the at least one nozzle hole, between the nozzle needle and an inner wall surface of the nozzle and that changes a cross-sectional area of the fuel supply route at a seat portion located on an upstream side of the each of the at least one nozzle hole in the fuel flowing direction, wherein:
the inner wall surface is formed in a tapered shape at the seat portion;
the nozzle needle has a seat surface, which is opposed to the inner wall surface with the fuel supply route therebetween; and
the nozzle needle changes the cross-sectional area of the fuel supply route by changing a distance between the seat surface and the inner wall surface.

19. The fuel injection apparatus according to claim 15, wherein the fuel injection apparatus supplies fuel to a diesel engine.

20. The fuel injection apparatus according to claim 15, further comprising an injection control means for controlling the separation position by variably controlling the flowing speed of fuel flowing through the each of the at least one nozzle hole.

21. The fuel injection apparatus according to claim 20, wherein:
the nozzle portion is disposed to inject fuel directly into a combustion chamber of an engine;
the nozzle portion performs main fuel injection to generate output torque, and performs subordinate fuel injection by injecting an smaller injection quantity of fuel than the main fuel injection before or after performing the main fuel injection;
the injection control means controls the flowing speed of fuel such that at least in a state where an injection ratio of the main fuel injection is higher than a first predetermined injection ratio, fuel separates at a position, where the cross-sectional area of the each of the at least one nozzle hole is smaller than the cross-sectional area at the separation position when an injection ratio of the subordinate fuel injection is higher than a second predetermined injection ratio; and
a maximum injection ratio of the subordinate fuel injection is lower than the first predetermined injection ratio, and is higher than the second predetermined injection ratio.

22. A fuel injection apparatus comprising a nozzle portion, into which fuel flows, wherein:
the nozzle portion includes at least one nozzle hole;
fuel is injected through the at least one nozzle hole;
each of the at least one nozzle hole is configured such that a separation position located between an inlet and outlet end portion of the each of the at least one nozzle hole is selectable according to a flowing speed of fuel, from:
the outlet end portion of the each of the at least one nozzle hole; and
other positions than the outlet end portion between the inlet and outlet end portion of the each of the at least one nozzle hole; and
at the separation position, fuel separates from a wall surface of the each of the at least one nozzle hole while flowing from the inlet end portion to the outlet end portion of the each of the at least one nozzle hole.

23. The fuel injection apparatus according to claim 22, wherein:
the each of the at least one nozzle hole has a plurality of separation points;
at each of the plurality of separation points, fuel flowing from the inlet end portion to the outlet end portion of the each of the at least one nozzle hole separates from the wall surface of the each of the at least one nozzle hole more easily when the flowing speed of fuel increases; and
the plurality of separation points includes the inlet end portion and the outlet end portion of the each of the at least one nozzle hole, and at least one position located between the inlet and outlet end portion of the each of the at least one nozzle hole.

24. The fuel injection apparatus according to claim 23, wherein the plurality of separation points is formed by sharply changing a changing rate of a cross-sectional area of the each of the at least one nozzle hole.

25. The fuel injection apparatus according to claim 22, further comprising:
a nozzle included in the nozzle portion, wherein the nozzle includes the at least one nozzle hole; and
a nozzle needle that is disposed inside the nozzle thereby to define a fuel supply route, through which fuel flows into the each of the at least one nozzle hole, between the nozzle needle and an inner wall surface of the nozzle and that changes a cross-sectional area of the fuel supply route at a seat portion located on an upstream side of the each of the at least one nozzle hole in the fuel flowing direction, wherein:
the inner wall surface is formed in a tapered shape at the seat portion;
the nozzle needle has a seat surface, which is opposed to the inner wall surface with the fuel supply route therebetween; and
the nozzle needle changes the cross-sectional area of the fuel supply route by changing a distance between the seat surface and the inner wall surface.

26. The fuel injection apparatus according to claim 22, wherein the fuel injection apparatus supplies fuel to a diesel engine.

27. The fuel injection apparatus according to claim 22, further comprising an injection control means for controlling the separation position by variably controlling the flowing speed of fuel flowing through the each of the at least one nozzle hole.

28. The fuel injection apparatus according to claim 27, wherein:
the nozzle portion is disposed to inject fuel directly into a combustion chamber of an engine;
the nozzle portion performs main fuel injection to generate output torque, and performs subordinate fuel injection by injecting an smaller injection quantity of fuel than the main fuel injection before or after performing the main fuel injection;
the injection control means controls the flowing speed of fuel such that at least in a state where an injection ratio of the main fuel injection is higher than a first predetermined injection ratio, fuel separates at a position, where the cross-sectional area of the each of the at least one nozzle hole is smaller than the cross-sectional area at the separation position when an injection ratio of the subordinate fuel injection is higher than a second predetermined injection ratio; and
a maximum injection ratio of the subordinate fuel injection is lower than the first predetermined injection ratio, and is higher than the second predetermined injection ratio.

29. A fuel injection apparatus comprising:
a nozzle, into which fuel flows, wherein:
the nozzle includes at least one nozzle hole;
fuel is injected through the at least one nozzle hole;
each of the at least one nozzle hole includes a nozzle hole outlet region; and
a cross-sectional area of the nozzle hole outlet region decreases one of continuously and stepwise in a direction opposite from a fuel flowing direction; and
a nozzle needle that is disposed inside the nozzle thereby to define a fuel supply route, through which fuel flows into the each of the at least one nozzle hole, between the nozzle needle and an inner wall surface of the nozzle and that changes a cross-sectional area of the fuel supply route at a seat portion located on an upstream side of the each of the at least one nozzle hole in the fuel flowing direction, to change a flowing speed of fuel flowing through the each of the at least one nozzle hole according to the cross-sectional area of the fuel supply route at the seat portion.

30. The fuel injection apparatus according to claim 29, wherein:
the nozzle hole outlet region includes at least one tapered hole;
each of the at least one tapered hole has a corresponding increase ratio, at which a cross-sectional area of the each of the at least one tapered hole increases in the fuel flowing direction; and
at least one of the corresponding increase ratio is larger than βf and smaller than βc, given:
βc, which is an increase ratio of the cross-sectional area of the fuel supply route in a direction from the seat portion toward a downstream side of the fuel supply route in the fuel flowing direction in a state where the cross-sectional area of the fuel supply route at the seat portion is minimized by the nozzle needle; and
βf, which is an increase ratio of the cross-sectional area of the fuel supply route in the direction from the seat portion toward the downstream side of the fuel supply route in the fuel flowing direction in a state where the cross-sectional area of the fuel supply route at the seat portion is maximized by the nozzle needle.
